(19) United States
(12) Patent Application Publication
(10) Pub. No.: US 2007/0252693 A1
(43) Pub. Date: Nov. 1, 2007

(54) System and method for surveilling a scene

(76) Inventor: Jocelyn Janson, Greenfield Park (CA)

Correspondence Address: INVENTION QUEBEC INC., Suite 202, 8065, Boul Viau, Montreal, QC, H1R 2T2, CA

(21) Appl. No.: 11/414,206

(22) Filed: May 1, 2006

(51) Int. Cl. G08B 13/00

(52) U.S. Cl. 340/541

(57) ABSTRACT

A method for surveilling a scene using a single camera, the scene including a first zone and a second zone, the first zone being associated with a first predetermined alarm action to be performed upon movement being detected within the first zone, the second zone being associated with a second predetermined alarm action to be performed upon movement being detected within the second zone. The method includes: acquiring a first image of the scene using the camera, the first image including first image pixels representing both the first zone and the second zone; after the acquisition of the first image, acquiring a second image of the scene using the camera, the second image including second image pixels representing both the first zone and the second zone; detecting if a movement occurred within the first zone between the acquisition of the first and second images by comparing the first image pixels representing the first zone to the second image pixels representing the first zone; detecting if a movement occurred within the second zone between the acquisition of the first and second images by comparing the first image pixels representing the second zone to the second image pixels representing the second zone; upon the detection of a movement in the first zone, performing the first predetermined alarm action; and upon the detection of a movement in the second zone, performing the second predetermined alarm action.

### FIELD OF THE INVENTION

The present invention relates generally to the field of surveillance and is particularly concerned with a system and a method for surveilling a scene.

### BACKGROUND OF THE INVENTION

Residential surveillance systems have traditionally relied on motion detectors for detecting motions and the presence of smoke within a house or any other residential building. Upon the detection of motion, a siren is typically activated and, in some cases, an alarm signal is sent to a central alarm station. Then, employees of the central alarm station may notify emergency services, such as the fire department and the police, that an event has occurred at the location wherein the event has occurred.

Such traditional alarm systems require that an intended user buys specialized hardware that needs to be professionally installed inside the house. Therefore, such systems are typically relatively expensive to buy. In addition, these systems are typically relatively inflexible and only allow the intended user to define a few distinct actions to be performed when an event occurs.

In commercial and industrial settings, surveillance systems typically include many cameras that perform surveillance around and into a building. Such cameras are typically linked to a video recorder and to video monitors allowing an intended user to review past images acquired in and around the building and to record new images from the cameras.

Many commercial systems include motion detection modules that are linked to each of the cameras. Then, it is feasible to define many zones around and into the building, each zone being associated with a different action that must be performed upon the detection of motion within the zone. However, such commercially available surveillance systems are typically relatively expensive and are therefore typically out of reach of residential users.

In addition, the commercial systems typically require that more than one camera be used to perform surveillance of different portions of an environment around the building or into the building. Therefore, limitations brought by the hardware used in these systems make these systems also relatively inflexible.

Accordingly, there exists a need for an improved system and method for surveilling a scene.

It is a general object of the present invention to provide such a system and method for surveilling a scene.

### SUMMARY OF THE INVENTION

In a first broad aspect, the invention provides a method for surveilling a scene using a single camera, the scene including a first zone and a second zone, the first zone being associated with a first predetermined alarm action to be performed upon movement being detected within the first zone, the second zone being associated with a second predetermined alarm action to be performed upon movement being detected within the second zone. The method includes:
acquiring a first image of the scene using the camera, the first image including first image pixels representing both the first zone and the second zone;
after the acquisition of the first image, acquiring a second image of the scene using the camera, the second image including second image pixels representing both the first zone and the second zone;
detecting if a movement occurred within the first zone between the acquisition of the first and second images by comparing the first image pixels representing the first zone to the second image pixels representing the first zone;
detecting if a movement occurred within the second zone between the acquisition of the first and second images by comparing the first image pixels representing the second zone to the second image pixels representing the second zone;
upon the detection of a movement in the first zone, performing the first predetermined alarm action; and

upon the detection of a movement in the second zone, performing the second predetermined alarm action.

In another broad aspect, the invention provides a system for surveilling a scene, the scene including a first zone and a second zone, the first zone being associated with a first predetermined alarm action to be performed upon movement being detected within the first zone, the second zone being associated with a second predetermined alarm action to be performed upon movement being detected within the second zone. The system includes:
a camera for acquiring a first image of the scene, the first image including first image pixels representing both the first zone and the second zone; and after the acquisition of the first image, acquiring a second image of the scene, the second image including second image pixels representing both the first zone and the second zone;
a motion detector connected to the camera for receiving the first and second images from the camera; detecting if a movement occurred within the first zone between the acquisition of the first and second images by comparing the first image pixels representing the first zone to the second image pixels representing the first zone; and detecting if a movement occurred within the second zone between the acquisition of the first and second images by comparing the first image pixels representing the second zone to the second image pixels representing the second zone;
an alarm module connected to the motion detector for upon the detection of a movement in the first zone, performing the first predetermined alarm action; and upon the detection of a movement in the second zone, performing the second predetermined alarm action.

In yet another broad aspect, the invention provides a machine readable storage medium containing a program element for surveilling a scene using a single camera, the program element being executable by a computing device, the scene including a first zone and a second zone, the first zone being associated with a first predetermined alarm action to be performed upon movement being detected within the first zone, the second zone being associated with a second predetermined alarm action to be performed upon movement being detected within the second zone. The program element includes:
an input module for receiving a first image of the scene from the camera, the first image including first image pixels representing both the first zone and the second zone; and after the acquisition of the first image, receiving a second image of the scene, the second image including second image pixels representing both the first zone and the second zone;
a motion detection module for detecting if a movement occurred within the first zone between the acquisition of the first and second images by comparing the first image pixels representing the first zone to the second image pixels representing the first zone; and detecting if a movement occurred within the second zone between the acquisition of the first and second images by comparing the first image pixels representing the second zone to the second image pixels representing the second zone;
an alarm module for upon the detection of a movement in the first zone, performing the first predetermined alarm action; and upon the detection of a movement in the second zone, performing the second predetermined alarm action.

Advantageously, the method may be performed using a relatively inexpensive system including a program element in the form of software running on a personal computer and a relatively inexpensive camera. This is in part made possible by recent technological developments such as developments in image acquisition devices and the Internet, which led to the development of relatively inexpensive cameras. Such cameras are often owned by computer owners and used, for example, as web cams. Therefore, the software allows an intended user to use hardware that he already owns to perform a new function, namely the surveillance of his home.

Advantageously, the invention allows also the intended user to use a single camera, which therefore brings cost-effectiveness to the system, to perform different actions when motion is detected at different locations within or outside a house. This advantage is an improvement over prior art surveillance systems which required the use of many cameras if many different actions were to be performed according to a zone in which a movement occurred.

The system and software are also relatively easy to use and relatively flexible and customizable by the intended user.

In some embodiments of the invention, a sensitivity of the movement detection is adjustable individually for each zone. In these embodiments, synergetic effects between the adjustment of the sensitivity and the selection of different predetermined alarm actions for each zone are created. For example, in some zones, a first predetermined alarm action may be performed when a relatively small movement is detected while a second predetermined alarm action may be performed when a relatively large movement is detected. Also, in another example, in some zones, a first predetermined alarm action may be performed when a relatively small movement is detected while in other zones a second predetermined alarm action when a relatively large movement is detected.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

An embodiment of the present invention will now be disclosed, by way of example, in reference to the following drawings in which:

FIG. 1, in a schematic view, illustrates an image representing a surveilled scene;

FIG. 2, in a flowchart, illustrates a method for surveilling the scene of FIG. 1 in accordance with an embodiment of the present invention;

FIG. 3, in a schematic view, illustrates a system for performing the method of FIG. 2;

FIG. 4, in a schematic view, illustrates a program element for performing the method of FIG. 2; and

FIG. 5, in a schematic view illustrates a computing device for executing a program element implementing the method of FIG. 2.

### DETAILED DESCRIPTION

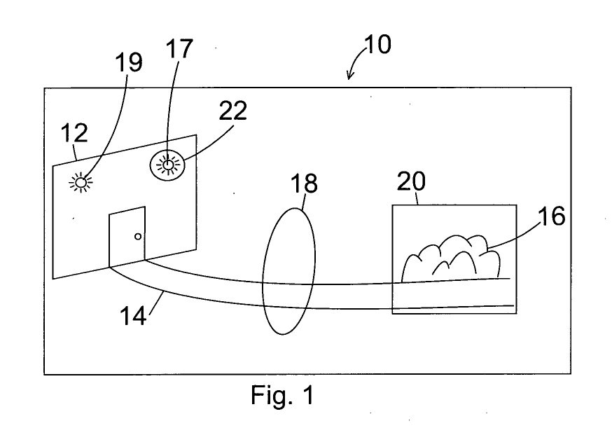

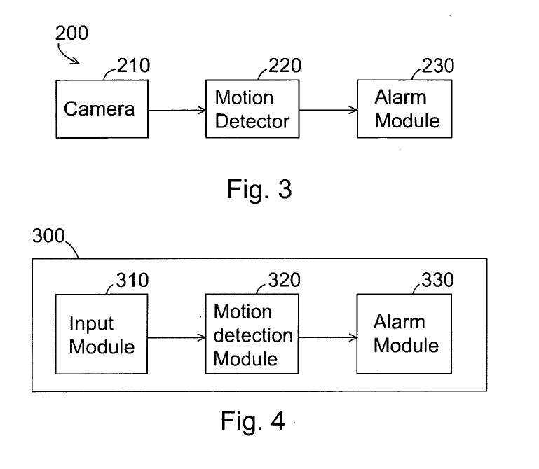

FIG. 1, in a schematic view, illustrates an image 10 representing a scene that may be surveilled using a single camera (shown in FIG. 3). For example, the scene includes a building 12, a walkway 14, bushes 16 and a light 17. A first zone 18, a second zone 20 and a third zone 22 are defined within the scene. Each of the first, second and third zones 18, 20 and 22 is associated respectively with a first, second and third predetermined alarm action to be performed upon movement being detected within the associated zone, as described in further details hereinbelow. Although the image 10 representing a scene having three zones 18, 20 and 22 is used as an example throughout the present description, the reader skilled in the art will readily appreciate that the method of the present invention may be performed in scenes including any suitable number of zones.

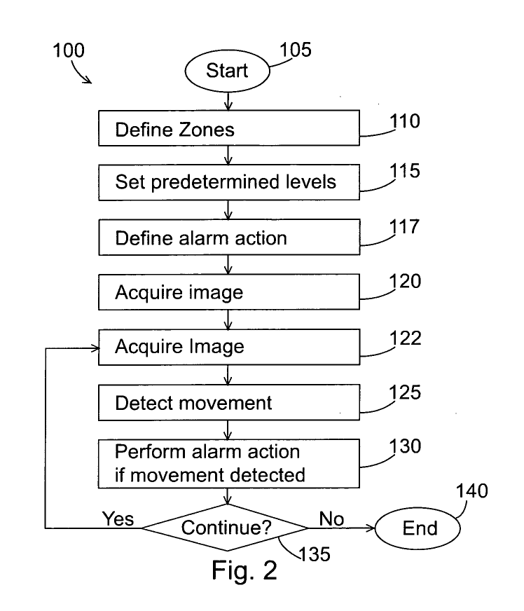

The invention relates to a method 100, illustrated in FIG. 2, for surveilling the scene represented by the image 10. In some embodiments of the invention, the method is performed using a system 200 seen in FIG. 3. The system 200 includes a camera 210 connected to motion detector 220. The motion detector 220 is in turn connected to an alarm module 230.

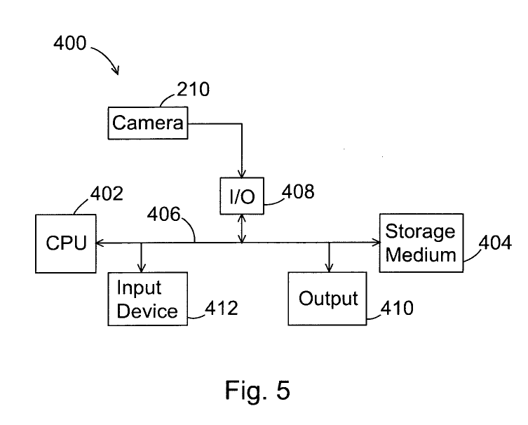

In other embodiments of the invention, the method 100 is performed by a program element 300, illustrated schematically on FIG. 4, contained by a machine readable storage medium. The program element 300 includes an input module 310, a motion detection module 320 and an alarm module 330. Therefore, the program element 300 performs functions similar to the functions performed by the motion detector 220 and the alarm module 230. For example, the program element 300 may be run onto a computing device 400, seen in FIG. 5, described in further details hereinbelow.

An example of a computing device 400 suitable for executing the program element 300 is illustrated in FIG. 5. However, using any other type of suitable computing device is within the scope of the invention. The computing device 400 includes a Central Processing Unit (CPU) 402 connected to a storage medium 404 over a data bus 406. Although the storage medium 404 is shown as a single block, it may include a plurality of separate components, such as a floppy disk drive, a fixed disk, a tape drive and a Random Access Memory (RAM), among others. The computing device 400 also includes an Input/Output (I/O) interface 408 that connects to the data bus 406. The computing device 400 communicates with outside entities, such as for example the camera 210 through the I/O interface 408. In a non-limiting example of implementation, the I/O interface 408 also includes a network interface connected to a network (not seen in the drawings).

The computing device 400 also includes an output device 410 to communicate information to an intended user. In the example shown, the output device 410 includes a display for displaying images acquired using the camera 210. Optionally, the output device 410 includes a printer or a loudspeaker. The computing device 400 further includes an input device 412 through which the user may input data or control the operation of a program element executed by the CPU 402. The input device 412 may include, for example, any one or a combination of the following: keyboard, pointing device, touch sensitive surface or speech recognition unit, among others. When the computing device 400 is in use, the storage medium 404 holds the program element 300, which is executed by the CPU 402. In addition, the storage medium 404 holds data required to perform the method 100.

A flowchart illustrating the method 100 for surveilling the scene is shown in FIG. 2. The method starts at step 105. At step 110, the first, second and third zones 18, 20 and 22 are defined. Afterwards, at step 115 and 117, predetermined levels defining the sensitivity of movement detection are set and predetermined alarm actions associated with each of the zones are defined for each of the first, second and third zones 18, 20 and 22. Then, at steps 120 and 122, a first image and a second image are respectively acquired, and, at step 125, motion is detected within each of the zones 18, 20 and 22. If movement is detected within one of the zones 18, 20 and 22, the predetermined alarm action associated within the zone is performed at step 130. At step 135, a decision as to whether the method should continue or not is taken. If the method is finished, the method 100 branches to step 140 where the method ends. Otherwise, the method branches to step 122 and another image is acquired.

At step 110, the first, second and third zones 18, 20 and 22 are defined. In some embodiments of the invention, the zones are predetermined zones and are therefore pre-defined without the possibility of changes by the intended user within the system 200 or the programmed element 300. In other embodiments of the invention, the intended user may use the input device 412 and the output device 410 to interactively define the first, second and third zones 18, 20 and 22 onto the image 10.

As seen in FIG. 1, some zones may be substantially rectangular and are therefore described by the coordinates of one of their corners and their extent, horizontally and vertically into the image 10. This is the case, for example, for the first zone 20. In other zones, such as for example the second zone 18, a user may use a mouse or any other input device to define onto the image 10 the shape of the zone. Methods for defining zones, for example using pointing devices, command line inputs or text files describing the zones, are well-known in the art and will therefore not be described in further details.

At step 115, predetermined levels are set. The predetermined levels are predetermined levels that are each associated with a respective zone 18, 20 or 22. The predetermined levels allow adjusting the sensitivity of the movement within each zone 18, 20 and 22. In other words, a movement is to be detected at step 125 only if a motion level indicative of the extent of a speed of the movement within one of the zones exceeds the predetermined level associated with this zone. Methods for setting predetermined levels adjusting sensitivity to motion are well-known in the art and will therefore not be described in further details herein.

Adjusting the predetermined level allows to adjust the sensitivity of the method 100 to movements. For examples, the first zone 18 includes bushes 16. It is to be expected that during windy days the leaves of the bushes 16 will move and potentially to create false alarms as the moving leaves create movement within the first zone 18. Therefore, it is desired that the sensitivity movement detection within the zone 18 be relatively small.

However, adjusting the predetermined level to too large a value would result in no motion be detected except during the presence of very large motions within the zone. Accordingly, the predetermined level is set to adjust a sensitivity of the detection of movement within a zone. This allows adjusting a trade-off between false positives and false negatives in the detection of the movement within each of the zones.

At step 117, the predetermined alarm actions associated with each of the zones 18, 20 and 22 are defined. As for the zones shapes and locations, in some embodiments of the invention, the predetermined alarm actions are fixed and, therefore, cannot be changed by the intended user. In other embodiments of the invention, the predetermined alarm actions may be defined by the intended user.

The alarm actions are actions that are performed when a movement is detected within one of the zones. For example, referring to FIG. 1, if movement is detected within zone 18, which indicates that someone may be approaching the building 12, a warning signal may be issued to that person. The warning signal may, for example, include a voice advising the person that it is approaching a restricted area and should therefore turn back.

If the person further approaches the building 12, he will enter the zone 20, which is closer to the building 12 than the zone 18. If someone enters the zone 20, it may indicate that he intends on penetrating the building 12. In this case, an alarm may be issued to a security guard to advise the security guard that someone may be close to entering the building.

The predetermined alarm actions that may be performed by the system are many. A non-exhaustive list of such actions includes emitting a sound, the sound having the ability to be heard either by a person approaching a restricted area or by someone performing surveillance, storing an image in which the movement has been detected on the storage medium 404, storing a video including the zone in which a movement has been detected on the storage medium 404, sending an image or a video over a network through the I/O interface 408 to a location wherein surveillance may be performed by a human being, highlighting the zone in which a movement occurred on an image displayed to the intended user through the output device 410, displaying a text to the intended user through the output device 410, storing a text or binary string in a file located on the storage medium 404, among others.

At step 120 and 122 a first and a second image are acquired. The first time that the method 100 is run, there is a need to acquire at least two images so that movement may be detected. In subsequent iterations, it is possible to compare the last acquired image to a new image to perform movement detection, and it is therefore possible to acquire only a single image in these further loops.

The first and second images are acquired using the camera 210. The first image including first image pixels representing the first, the second and the third zones 18, 20 and 22. After the acquisition of the first image, a second image is acquired using the camera 210, the second image including second image pixels representing the first, the second and the third zones 18, 20 and 22.

Then, at step 125, there is a detection of the occurrence of a movement within each of the zones 18, 20 and 22 between the acquisition of the first and second images. To that effect, within each of the zones 18, 20 and 22, the first image pixels representing the zone are compared to the second image pixels representing the zone. Movement detection is performed using any suitable conventional method, such as for example the Kanade-Lucas-Tomasi point tracking method or the Richefeu-Manzanera hybrid differential filter, among others.

In some embodiments of the invention, detecting movement within each zone 18, 20 and 22 includes computing a motion level for each zone 18, 20 and 22, the motion level being indicative of the extent and speed of the movement within the zone 18, 20 and 22. The motion level allows quantifying, using a single number, the movement that occurred within the zone between the acquisition of the first and second images. The computation of the motion level typically includes averaging over the whole zone 18, 20 and 22 a local movement measures computed using one of the above-mentioned movement detection methods.

In these embodiments, there is a detection of movement within the zone 18, 20 and 22 if the motion level computed for the zone 18, 20 and 22 is larger than the predetermined level set for the zone at step 115.

Then, at step 130, the predetermined alarm actions associated with the zones in which movement has been detected are performed.

In some embodiments of the invention, the last acquired image is displayed onto a display device. This image may, for example, be displayed during step 122 of acquiring the image. In these embodiments, having the predetermined alarm action associated with each zone including highlighting the zone in which the movement has been detected in the displayed image may be particularly advantageous as it immediately brings the attention of someone looking at the image to a zone wherein a problem may have occurred.

In some embodiments of the invention, the system 200 and the program element 300 allow to modify the position, the shape or both the position and the shape of each zone or to add zones to the scene while the method 100 is performed. Therefore, the system is flexible as it allows the intended user to modify the functionality performed by the system 200 and program element 300 according to events that occur in the scene. In these embodiments of the invention, it is also possible to modify the predetermined alarm action and the predetermined level associated with each zone in a similar manner while the method 100 is performed.

In some embodiments of the invention, one or more zones, illustrated for example by the third zone 22 on FIG. 1, is a camera orientation zone that serves to detect if the camera 210 has been moved or if a fixed image has been put in front of the camera 210. Typically, the third zone 22 is then a zone located at a position where no movement is expected to occur within the scene. Indeed, if the camera 210 is moved or if a fixed image representing the scene is affixed to the front of the camera 210, motion detection will not occur even if motion happens within the scene. Therefore, there is a need to issue a specific alarm if the camera 210 has been moved.

In these embodiments, a predetermined fixed object in the scene is included in the third zone 22. Upon detection of motion within the third zone 22, an alarm indicating that the camera has been moved is issued. In some embodiments of the invention, the third zone 22 includes essentially only the predetermined fixed object.

In some embodiments of the invention, the predetermined fixed object has a predetermined color. In other embodiments of the invention, the fixed object is an object 17 emitting light at a predetermined illumination level, an object 17 emitting light having a predetermined color spectrum or an object 17 emitting light according to a time varying predetermined pattern of illumination level. This last example, prevents someone from photographing the scene and then putting an image of the scene in front of the camera 210 so as to simulate the scene. Indeed, the method 100 may then detect the presence of the predetermined illumination level time variation pattern within acquired images. Upon the absence of this time varying predetermined pattern of illumination level, an alarm may be issued to indicate that this pattern is not present into the acquired images.

In other embodiments of the invention, another zone 19, for example, may be used with the object zone 17 to ensure that the camera 210 is not rotated about its longitudinal axis. Indeed, it is possible that the camera may be moved such that the third zone 22 does not move within the field of view of the camera 210. In this case, having another zone that serves to detect camera position changes ensures that the change in camera position or orientation is detected.

In some embodiments of the invention, a synergy is created by the association of each zone with a distinct predetermined level for movement detection and a distinct alarm action. Indeed relatively flexible systems may then be assembled using relatively few parts. For example, it is possible to set a relatively small predetermined level for a first zone located close to a ceiling in a room and a relatively large predetermined level for a second zone located close to a window in a room.

Then, the first zone may be used for example for fire detection as smoke passing through the first zone will cause a movement detection in this zone. The first predetermined action associated with the first zone may then be to alert the fire department that there is a likely fire in the room. The second zone may be used for example for trespassing detection. If an intruder passes in front of the window, an alarm may be sent to a police station to alert the police of an illegal trespassing. Therefore, a single device, namely the camera 210, may acquire the information required to perform many functions.

In other embodiments of the invention, the two of the zones may be substantially similarly shaped and located. In this case, the sensitivity on one of the zones may be set relatively low so that only large movement lead to the performance of the alarm action associated with this zone. This alarm action may for example include notifying the police that trespassing has occurred. The sensitivity on the other zone may be set relatively high so that small movement lead to the performance of the alarm action associated with this zone. This alarm action may for example include using a speaker play a message warning that someone may be approaching private property and should move away. In this example, movements occurring at a larger distance from the camera 210 lead to the warning message being played while movement occurring at a smaller distance from the camera lead to the police being notified.

While specific examples of synergies created by the association of each zone with a distinct predetermined level for movement detection and a distinct alarm action have been described, the reader skilled in the art will readily appreciate that this synergy is usable in any other suitable manner.

In the system 200, steps 120 and 122 typically performed by the camera 210, step 125 is typically performed by the moton detector 220 and step 130 is typically performed by the alarm module 230. Therefore, the camera 210 sends the acquired images to the motion detector 220. The motion detector 220 receives the images from the camera 210 and detects if the movement occurred within each of zones 18, 20 and 22. Upon detection of the movement within one of the zones 18, 20 and 22, a signal is sent to the alarm module 230 so that the alarm module may perform the predetermined alarm action associated with each zone in which a movement occurred.

In embodiments of the invention wherein the method 100 is performed by the program element 300, the input module 310 receives the first and second images of the scene from the camera 210, the motion detection module 320 receives the first and second images from the input module and detects is a movement occurred within each of the zones 18, 20 and 22 between the acquisition of first and second images, similarly to step 225 described hereinabove. Then, the alarm module performs the alarm action associated with each of the zones 18, 20 and 22 in which a movement has been detected, as described hereinabove in relation with step 130.

Although the present invention has been described hereinabove by way of preferred embodiments thereof, it can be modified, without departing from the spirit and nature of the subject invention as defined in the appended claims.

What is claimed is:

1. A method for surveilling a scene using a single camera, the scene including a first zone and a second zone, the first zone being associated with a first predetermined alarm action to be performed upon movement being detected within the first zone, the second zone being associated with a second predetermined alarm action to be performed upon movement being detected within the second zone, said method comprising:
acquiring a first image of the scene using the camera, the first image including first image pixels representing both the first zone and the second zone;
after the acquisition of the first image, acquiring a second image of the scene using the camera, the second image including second image pixels representing both the first zone and the second zone;
detecting if a movement occurred within the first zone between the acquisition of the first and second images by comparing the first image pixels representing the first zone to the second image pixels representing the first zone;
detecting if a movement occurred within the second zone between the acquisition of the first and second images by comparing the first image pixels representing the second zone to the second image pixels representing the second zone;
upon the detection of a movement in the first zone, performing the first predetermined alarm action; and
upon the detection of a movement in the second zone, performing the second predetermined alarm action.

2. A method as defined in claim 1, wherein
said detection of said movement within the first zone includes computing a first motion level indicative of the extent and speed of the movement within the first zone, said movement being detected within the first zone if said first motion level is larger than a first predetermined level;
said detection of said movement within the second zone includes computing a second motion level indicative of the extent and speed of the movement within the second zone, said movement being detected within the second zone if said second motion level is larger than a second predetermined level.

3. A method as defined in claim 2, further comprising
setting said first predetermined level to adjust a sensitivity of said detection of said movement in the first zone.

4. A method as defined in claim 1, wherein
the first zone includes a predetermined fixed object in the scene, the predetermined fixed object being located at a location wherein no movement is expected to occur; and
the first predetermined alarm action includes issuing an alarm indicating that the camera has been moved.

5. A method as defined in claim 4, wherein the first zone includes essentially only the predetermined fixed object.

6. A method as defined in claim 4, wherein the predetermined fixed object is selected from the set consisting of an object emitting light at a predetermined illumination level, an object emitting light having a predetermined color spectrum and an object emitting light according to a time varying predetermined pattern of illumination level.

7. A method as defined in claim 1, further comprising defining a third zone, the third zone being associated with a third predetermined alarm action to be performed when movement is detected within the third zone.

8. A method as defined in claim 1, further comprising modifying one of the position, the shape or both the position and the shape of one of the first and second zones.

9. A method as defined in claim 1, further comprising changing at least one of the first predetermined alarm action and the second predetermined alarm action.

10. A method as defined in claim 1, wherein the first and second predetermined alarm actions are selected from the set consisting of emitting a sound, the sound having the ability to be heard either by a person approaching a restricted area or by someone performing surveillance, storing the second image on a storage medium, storing a video including the zone from the first and second zones in which a movement has been detected on a storage medium, sending the second image over a network to a location wherein surveillance is performed by a human being, sending video including the second image over a network to a location wherein surveillance is performed by a human being, highlighting the zone from the first and second zones in which a movement occurred on an image displayed to an intended user, displaying a text to an intended user through an output device, storing a text or binary string in a file located on a storage medium, execute a computer command, run a process or software on a computer, emulate keyboard and mouse on a computer, increment counter on movement detection, send messages or trigs to a third party software, hide or close confidential or private documents that are being displayed by a computer, mute any sound or music.

11. A method as defined in claim 1, wherein detecting said movement includes detecting if a movement occurred within each of the first and second zones by using a method selected from the set consisting of Kanade-Lucas-Tomasi point tracking method and the Richefeu-Manzanera hybrid differential filter

12. A method as defined in claim 1, further comprising displaying said second image on a display device.

13. A method as defined in claim 12, wherein one of the first and second predetermined alarm actions includes highlighting the zone in which a movement has been detected in said second image.

14. A system for surveilling a scene, the scene including a first zone and a second zone, the first zone being associated with a first predetermined alarm action to be performed upon movement being detected within the first zone, the second zone being associated with a second predetermined alarm action to be performed upon movement being detected within the second zone, said system comprising:
a camera for
acquiring a first image of the scene, the first image including first image pixels representing both the first zone and the second zone; and
after the acquisition of the first image, acquiring a second image of the scene, the second image including second image pixels representing both the first zone and the second zone;
a motion detector connected to said camera for
receiving the first and second images from the camera;
detecting if a movement occurred within the first zone between the acquisition of the first and second images by comparing the first image pixels representing the first zone to the second image pixels representing the first zone; and
detecting if a movement occurred within the second zone between the acquisition of the first and second images by comparing the first image pixels representing the second zone to the second image pixels representing the second zone;
an alarm module connected to said motion detector for
upon the detection of a movement in the first zone, performing the first predetermined alarm action; and
upon the detection of a movement in the second zone, performing the second predetermined alarm action.

15. A machine readable storage medium containing a program element for surveilling a scene using a single camera, said program element being executable by a computing device, the scene including a first zone and a second zone, the first zone being associated with a first predetermined alarm action to be performed upon movement being detected within the first zone, the second zone being associated with a second predetermined alarm action to be performed upon movement being detected within the second zone, said program element comprising:
an input module for
receiving a first image of the scene from the camera, the first image including first image pixels representing both the first zone and the second zone; and
after the acquisition of the first image, receiving a second image of the scene, the second image including second image pixels representing both the first zone and the second zone;
a motion detection module for
detecting if a movement occurred within the first zone between the acquisition of the first and second images by comparing the first image pixels representing the first zone to the second image pixels representing the first zone; and
detecting if a movement occurred within the second zone between the acquisition of the first and second images by comparing the first image pixels representing the second zone to the second image pixels representing the second zone;
an alarm module for
upon the detection of a movement in the first zone, performing the first predetermined alarm action; and
upon the detection of a movement in the second zone, performing the second predetermined alarm action.
